(19) United States
(12) Patent Application Publication
(10) Pub. No.: US 2014/0002856 A1
(43) Pub. Date: Jan. 2, 2014

(54) IMAGE FORMING APPARATUS, IMAGE FORMING SYSTEM, AND IMAGE FORMING METHOD

(71) Applicant: KYOCERA Document Solutions Inc., Osaka-shi (JP)

(72) Inventor: Takeo Shimizu, Osaka-shi (JP)

(21) Appl. No.: 13/926,167

(22) Filed: Jun. 25, 2013

(30) Foreign Application Priority Data
Jun. 27, 2012 (JP) 2012-143795

(51) Int. Cl. G06F 3/12; H04N 1/00

(52) U.S. Cl. CPC G06F 3/1294; H04N 1/0001
USPC 358/1.15

(57) ABSTRACT

An image forming apparatus of the present disclosure includes a receiving unit and a terminal specific information setting unit. The receiving unit receives print data concerning a print job through a network from a terminal. The terminal specific information setting unit acquires terminal specific information of the terminal contained in the print data and executes user specific setting using the terminal specific information.

### INCORPORATION BY REFERENCE

This application is based upon and claims the benefit of priority from the corresponding Japanese Patent Application No. 2012-143795, filed in the Japan Patent Office on Jun. 27, 2012, the entire contents of which are incorporated herein by reference.

### BACKGROUND

The present disclosure relates to an image forming apparatus, an image forming system, and an image forming method, more particularly to an image forming apparatus which allows execution of user specific setting, and an image forming system and an image forming method therefor.

As an image forming apparatus which is a multifunctional printer or the like whose permission right is controlled conventionally, there has existed an apparatus having a function for executing “personalization” setting (user specific setting). The “personalization” setting refers to, for example, storing a setting for a user account for authentication, designation of a user's storage folder in a terminal such as a personal computer (PC), storage of an address book about transmission destinations, setting of a screen layout and the like. The personalization setting increases convenience for a user. However, the personalization setting has to be carried out by a user himself through an operation panel unit of the multifunctional printer. For example, when as a personalization setting, making a setting for transmission of an image data picked up by scanning to a user's PC folder from a multifunctional printer by way of server message block (SMB), specialized information such as a user ID, IP address, domain or the like has to be input. Thus, ordinary users may feel it difficult and burdensome to make such a setting, which is a problem to be solved. Furthermore, a user has to be informed of a terminal's IP address and domain, and they may feel it burdensome to input those data into the multifunctional printer, which is another problem to be solved.

As a conventional technology, there exists an external device document input/output apparatus (hereinafter referred to as conventional art 1) which includes a means for registering such setting information in a shared media. According to the conventional art 1, when a user makes an access from a server PC to a multifunctional printer, a folder indicated in the user management information is registered in a shared media, as home directory, together with each storage medium of the apparatus so as to achieve directory registration. Thus, the conventional art 1 exerts such an effect that a document file can be easily exchanged with each information apparatus appropriately.

However, according to the conventional art 1, it is necessary to use a server PC which an administrator or the like uses and therefore, the technology based on the conventional art 1 cannot be applied to all users of the multifunctional printer, which is still another problem to be solved. Thus, an administrator has to make a setting for the personalization of each user, which takes considerable time and labor.

### SUMMARY

An image forming apparatus of the present disclosure includes a receiving unit and a terminal specific information setting unit. The receiving unit receives print data concerning a print job through a network from a terminal. The terminal specific information setting unit acquires terminal specific information of the terminal contained in the print data and executes user specific setting using the terminal specific information.

An image forming system of the present disclosure is an image forming system which includes a terminal having a first network transmission/receiving unit which is connected to a network to transmit print data, and an image forming apparatus which includes a second network transmission/receiving unit which receives print data from the terminal. The terminal contains a storage unit which stores terminal specific information of the terminal and a control unit which causes the terminal specific information to be included in the print data to be printed by the image forming apparatus. The image forming apparatus contains a terminal specific information setting unit. The terminal specific information setting unit acquires terminal specific information of the terminal from the print data and executes user specific setting for connecting to the terminal using the terminal specific information.

An image forming method of the present disclosure is an image forming method to be executed by an image forming apparatus having a transmission/receiving unit for receiving print data concerning a print job through a network from a terminal and the image forming method includes: acquiring terminal specific information of the terminal contained in the print data and executing the user specific setting using the terminal specific information.

### BRIEF DESCRIPTION OF DRAWINGS

FIG. 1 is a system configuration diagram of an image forming system X according to an embodiment of the present disclosure.

FIG. 2 is a schematic cross-sectional view showing an internal structure of an image forming apparatus 1 according to an embodiment of the present disclosure.

FIG. 3 is a block diagram showing a control structure of the image forming apparatus 1 according to the embodiment of the present disclosure.

FIG. 4 is a block diagram showing a control structure of a terminal 200 according to the embodiment of the present disclosure.

FIG. 5 is a conceptual diagram of account information 90 according to the embodiment of the present disclosure.

FIG. 6 is a flow chart of print personalization processing according to the embodiment of the present disclosure.

FIG. 7 is a conceptual diagram of a personalization verification screen according to the embodiment of the present disclosure.

### DETAILED DESCRIPTION

### Embodiments

### Configuration of Image Forming System X

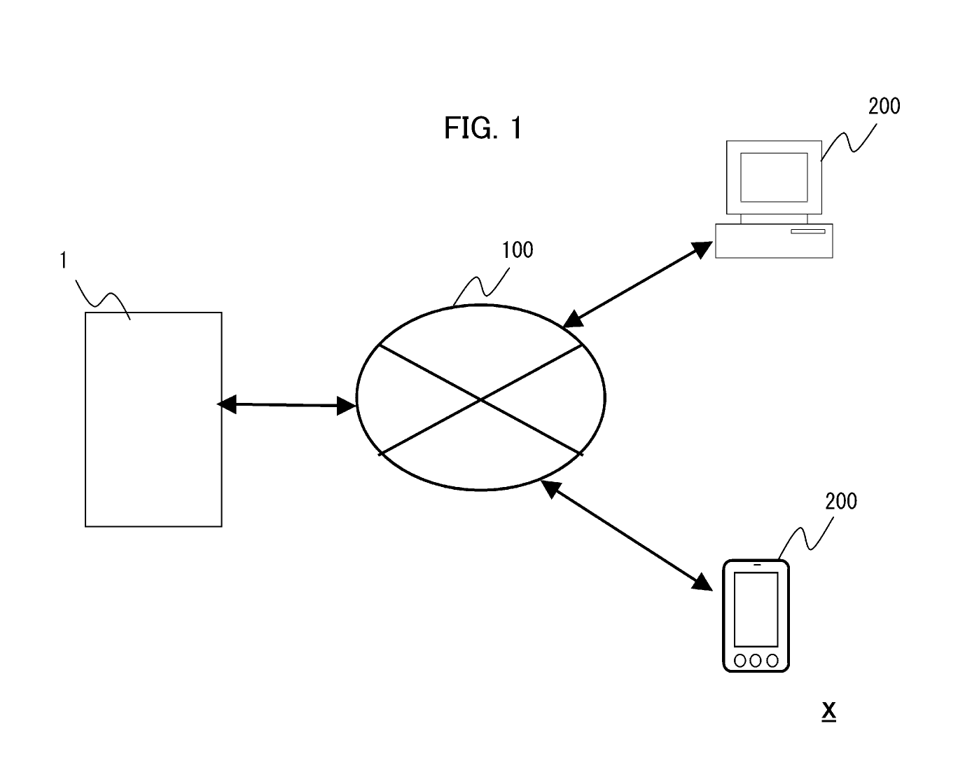

First, a system configuration of an image forming system X according to an embodiment of the present disclosure will be described with reference to FIG. 1. The image forming system X is configured by connecting an image forming apparatus 1, terminals 200 and the like to a network 100. The image forming apparatus 1 (information processing apparatus, computer) includes a copying machine, multifunction printer and the like. The copying machine, the multifunctional printer and the like can transmit and receive a variety of data including print data and image data obtained by scanning via the network 100 and authenticate each user's job by way of permission right control. The network 100 refers to a communication network including intranet, local area network (LAN), wide area network (WAN) such as Internet, extension telephone network, mobile phone network, PHS network and the like. The terminal 200 refers to apparatuses which can transmit print data to the image forming apparatus 1, such as PC, personal data assistant (PDA), smart phone, digital camera, smart TV, game machine and the like.

### Configuration of Image Forming Apparatus 1

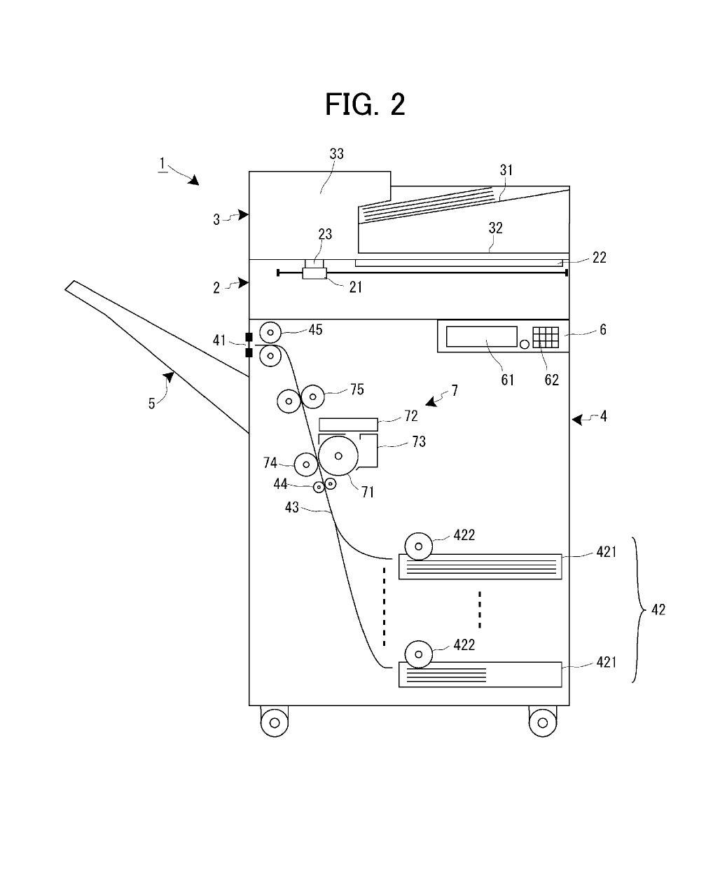

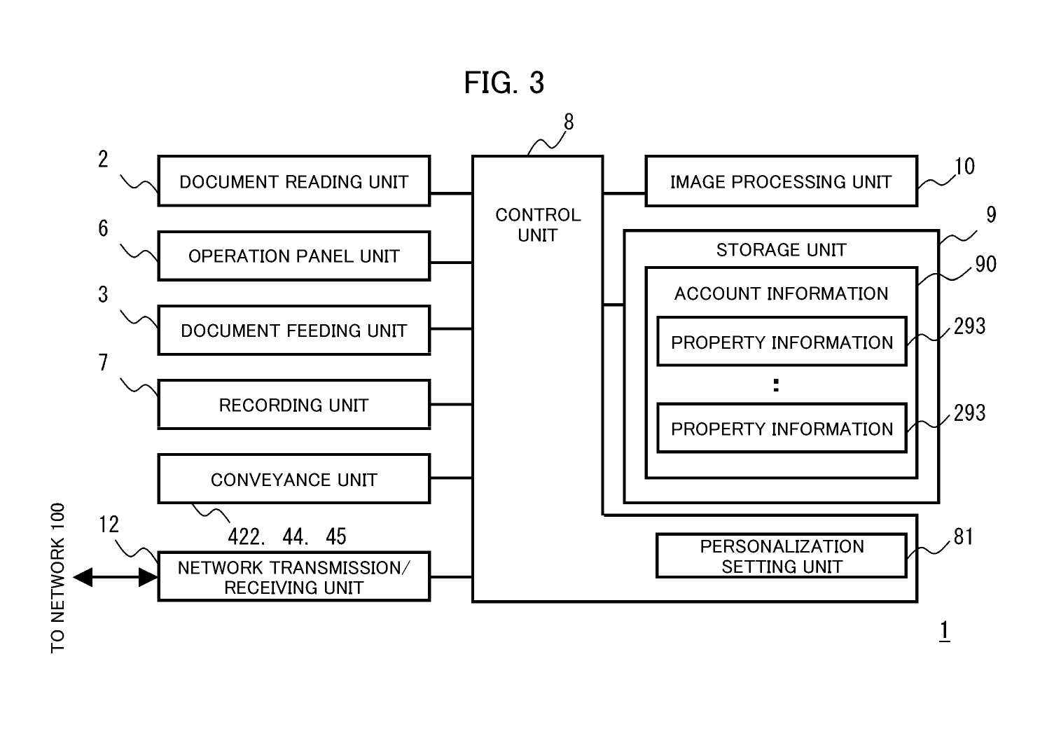

The configuration of the image forming apparatus 1 according to the embodiment of the present disclosure will be described in detail with reference to FIGS. 2 and 3. As shown in FIG. 2, the image forming apparatus 1 of the present embodiment includes a document reading unit 2, a document feeding unit 3, a main body unit 4, a stack tray 5, and an operation panel unit 6. The document reading unit 2 is arranged on top of the main body unit 4. The document feeding unit 3 is arranged on top of the document reading unit 2. The stack tray 5 is arranged on the side of a discharge port 41 for a recording paper, formed in the main body unit 4. The operation panel unit 6 is arranged on a front side of the image forming apparatus 1.

The document reading unit 2 includes a scanner 21, a platen glass 22, and a document reading slit 23. The scanner 21 is constituted of an exposure lamp, a charge coupled device (CCD) imaging sensor, complementary metal oxide semiconductor (CMOS) imaging sensor or the like, and configured to be moved in a direction of feeding a document by the document feeding unit 3. The platen glass 22 is composed of a transparent member such as glass. The document reading slit 23 is formed in a direction orthogonal to the direction of feeding a document by the document feeding unit 3.

When reading a document placed on the platen glass 22, the scanner 21 is moved to a position facing the platen glass 22 and scans the document placed on the platen glass 22 to read the document and acquire image data thereof, and then outputs the acquired image data to the main body unit 4. When reading a document carried by the document feeding unit 3, the scanner 21 is moved to a position facing the document reading slit 23 and reads the document through the document reading slit 23 synchronously with a document feeding operation of the document feeding unit 3 to acquire image data thereof and outputs the acquired image to the main body unit 4.

The document feeding unit 3 includes a document stacking unit 31, a document discharge unit 32, and a document carrying mechanism 33. Documents placed on the document stacking unit 31 are fed one by one in sequence by the document feeding mechanism 33, carried to a position facing the document reading slit 23 and after that, discharged to the document discharge unit 32. The document feeding unit 3 is structured to be capable of being turned over. Raising the document feeding unit 3 upward enables the top face of the platen glass 22 to be opened.

The main body unit 4 includes a recording unit 7, a paper feeding unit 42, a paper conveyance path 43, a conveyance roller 44, and a discharge roller 45. The paper feeding unit 42 includes a plurality of paper cassettes 421 each of which store recording papers different in size or orientation, and paper feeding rollers 422 for feeding the recording papers one by one to the paper conveyance path 43 from the paper feeding cassette 421. The paper feeding roller 422, the conveyance roller 44 and the discharge roller 45 function as a conveyance unit. The recording paper is carried by the conveyance unit. A recording paper fed to the paper conveyance path 43 by the paper feeding roller 422 is carried to the recording unit 7 by the conveyance roller 44. Then, a recording paper on which recording is achieved by the recording unit 7 is discharged onto the stack tray 5 by the discharge rollers 45.

The operation panel 6 includes a display unit such as LCD, buttons, a touch panel and the like. The buttons, the touch panel and the like contain a start key and ten-keys, and dispatch instructions for change-over of the operation mode for copying, facsimile transmission, scanner operation and the like, and instructions for execution of printing, transmission, receiving and the like of a selected document. That is, the operation panel unit 6 detects a user's instruction about each job of the image forming apparatus 1.

The recording unit 7 includes a photosensitive drum 71, an exposure unit 72, an image forming unit 73, a transfer unit 74, and a fixing unit 75. The exposure unit 72 is an optical unit including a laser unit, an LED array, a mirror, a lens and the like. The exposure unit 72 outputs light or the like based on image data to expose the photosensitive drum 71, and form electrostatic latent image on the surface of the photosensitive drum 71. The image forming unit 73 is a development unit which develops the electrostatic latent image formed on the photosensitive drum 71 using toner. The image forming unit 73 forms a toner image based on the electrostatic latent image on the photosensitive drum 71. The transfer unit 74 transfers a toner image, formed on the photosensitive drum 71 by the image forming unit 73, onto a recording paper. The fixing unit 75 fixes the toner image onto the recording paper by heating the recording paper to which the toner image has been transferred by the transfer unit 74.

FIG. 3 is a block diagram showing a substantial control structure of the image forming apparatus 1. The aforementioned document reading unit 2, document feeding unit 3, conveyance unit (paper feeding roller 422, conveyance roller 44, discharge roller 45), operation panel unit 6, and recording unit 7 are connected to the control unit 8. Operations of the respective units are controlled by the control unit 8. A storage unit 9, an image processing unit 10, a network transmission/receiving unit 12 (second network transmission/receiving unit) and the like are connected to the control unit 8.

The control unit 8 is an information processing unit, for example, a microcomputer containing a read only memory (ROM), a random access memory (RAM) or the like. A control program for controlling an operation of the image forming apparatus 1 is stored in the ROM. The control unit 8 and the image processing unit 10 read a control program stored in the ROM and expand the control program over the RAM so as to control the entire apparatus in correspondence to predetermined instruction information input from the operation panel unit 6 or an instruction from the terminal 200 (see FIG. 1). The control unit 8 further includes a personalization setting unit 81 (access information acquisition unit, terminal specific information setting unit) as a functional member.

The terminal specific information includes job setting corresponding to each job. The terminal specific information setting unit acquires a job setting from print data and uses the job setting for user-specific setting. The terminal specific information contains access information for connecting to a terminal. The image forming apparatus includes a transmission unit which is connected to the terminal using access information, and requests for other additional information than the access information. The terminal specific information setting unit uses the additional information for the aforementioned user-specific setting. As the terminal specific information, the terminal specific information setting unit uses at least one of the address of the terminal, user ID, password necessary for changing a file in the terminal, country setting, language setting and a name of a storage folder in the terminal.

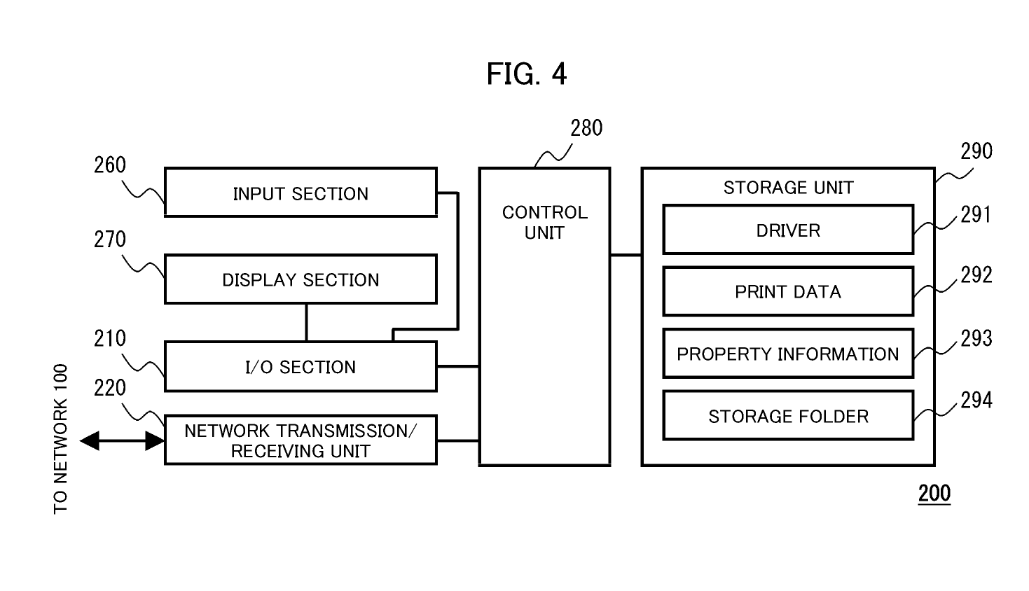

The storage unit 9 is a storage means such as a semiconductor memory, hard disk drive (HDD) or the like. The storage unit 9 stores image data obtained by scanning by the document reading unit 2, image data processed by the image processing unit 10, print data 292 transmitted from the terminal 200 or the like (see FIG. 4), a variety of files stored in a recording medium, data of thumbnail images and the like. The storage unit 9 further stores storage folders of respective users. Like a network attached storage (NAS), the storage folder stores image data which is read out by the document reading unit 2 and processed by the image processing unit 10 (image data obtained by scanning), image data read from a recording medium or the like, other print data 292 and the like. The storage unit 9 stores account information 90.

The image processing unit 10 serves as a control arithmetic operation unit for a digital signal processor (DSP) and a graphics processing unit (GPU). The image processing unit 10 performs a predetermined image processing on image data, for example, various image processings including enlargement/reduction processing, and image improvement processing such as density adjustment and tone adjustment. The image processing unit 10 converts an image read by the document reading unit 2 to “image data obtained by scanning” by the unit of a file based on such a format as PDF or TIFF. The “image data obtained by scanning” may be stored in a memory folder 294 of the storage unit 290 of a user's terminal 200 in which personalization setting is being performed via the network transmission/receiving unit 12 by the control unit 8.

The network transmission/receiving unit 12 is a network connecting unit containing a LAN board, a wireless transmitter, a telephone dialer, a coupler and the like for connecting to the network 100 (see FIG. 1). The network transmission/receiving unit 12 is capable of exchanging print data 292, property information 293 and the like with the terminal 200. The network transmission/receiving unit 12 can be connected to the terminal 200 through general authentication using access information acquired from the print data 292 to acquire mainly country/language information of the operating system, and then make country setting, language setting and the like as the property information 293. Furthermore, the network transmission/receiving unit 12 can acquire the property information 293 containing the additional information transmitted by the terminal 200 through a driver 291.

In the meantime, in the image forming apparatus 1, the control unit 8, the image processing unit 10 and the like may be formed integrally therewith like a GPU incorporated CPU or a chip-on-module package. Furthermore, the image forming apparatus 1 may include a fax transmission/receiving unit for making transmission/receiving with a fax, an upload section for uploading to an external server (not shown), a memory reader for reading a recording medium, an IC reader and the like.

### Configuration of Terminal 200

Next, a control structure of the terminal 200 will be described with reference to FIG. 4. As shown in FIG. 4, the terminal 200 includes an I/O section 210, an input section 260, a display section 270, a control section 280, a storage unit 290, and a network transmission/receiving unit 220 (first network transmission/receiving unit).

The I/O section 210 is a component for connecting to various kinds of peripheral equipment, which provides an interface for a DVI, an analog RGB, a HDMI, a USB, an IEEE1394 and serial, parallel, infrared, radio interfaces. The I/O section 210 is connected to the input section 260 and the display section 270.

The network transmission/receiving unit 220 is a unit for connecting to the network 100, such as 1000BASE-T/1000BASE-TX or the like specified LAN interface and the like. The terminal 200 can transmit/receive print data 292, property information 293 and the like via the network transmission/receiving unit 220. In the meantime, the network transmission/receiving unit 220 may be connected to the network 100 via an external hub, a router or the like.

The control unit 280 includes arithmetic/control capability such as a central processing unit (CPU), a micro processing unit (MPU), digital signal processor (DSP), graphics processing unit (GPU), application specific processor (ASIC) and the like. The control unit 280 executes respective programs stored in the storage unit 290 using a hardware resource. More specifically, the control unit 280 can transmit or receive respective kinds of information to/from the image forming apparatus 1 by executing the driver 291, or can function as a controller for instructing a user about setting such as additional information setting.

The storage unit 290 is a storage means such as a flash memory disk such as a random access memory (RAM) and a solid state drive (SSD), a hard disk drive (HDD), a magnetic tape unit, an optical disk unit. As well as an operating system (OS) for causing the terminal 200 to function as a computer, the storage unit 290 stores programs for word processor, spreadsheet software, drawing software, application/software such as WWW browser and mailer and other programs, data and the like. The control unit 280 can execute, read and write these program and data. The storage unit 290 stores the driver 291 (control program), the print data 292 (print job data), property information 293 (terminal specific information), and a storage folder 294.

The driver 291 is a program or the like to be executed by the control unit 280, which is a print driver program for the image forming apparatus 1. The driver 291 converts drawing data spooled at the time of printing by various applications to the print data 292 for the image forming apparatus 1. The driver 291 creates the print data 292 in conjunction with a print function of an OS, and is used for print job to be transmitted via the network transmission/receiving unit 220. The driver 291 can acquire information about OS and the like of the terminal 200, and store the acquired information in the property information 293. In addition, the driver 291 provides graphical user interface (GUI) which makes various settings for the property information 293 according to a user's instruction. The print data 292 is a print file such as a page-description language (PDL) file, which is created by driver 291's drawing based on raw data printed according to a variety of applications.

As unprinted metadata, the print data 292 may contain at least part of the property information 293. The print data 292 is transmitted from the network transmission/receiving unit 220 to the image forming apparatus 1. The property information 293 is data of personalization setting (user specific setting), which includes account information necessary for making an access to the terminal 200 and setting information of the driver 291. The property information 293 contains the aforementioned terminal information included in the print data 292. The detail of the property information 293 is described below.

The storage folder 294 is an area for storing image data obtained by scanning by the document reading unit 2 of the image forming apparatus 1. When personalization setting is made, the image forming apparatus 1 can transmit image data obtained by scanning, fax-received image data and the like to the storage folder 294 as a transmission destination, through SMB, FTP or the like. The control unit 280 of the terminal 200 can store these image data in the storage folder 294 using the OS and the driver 291.

The input section 260 is an input member such as a keyboard, a mouse or the like for making various settings and a setting of the property information 293. The property information 293 can be changed by user's inputting through the input section 260.

The display unit 270 is a display member such as an LCD display, organic EL display. The display unit 270 is used for changing the setting of the property information 293 and input of personalization permission information or additional information and the like.

### (Configuration of Property Information 293)

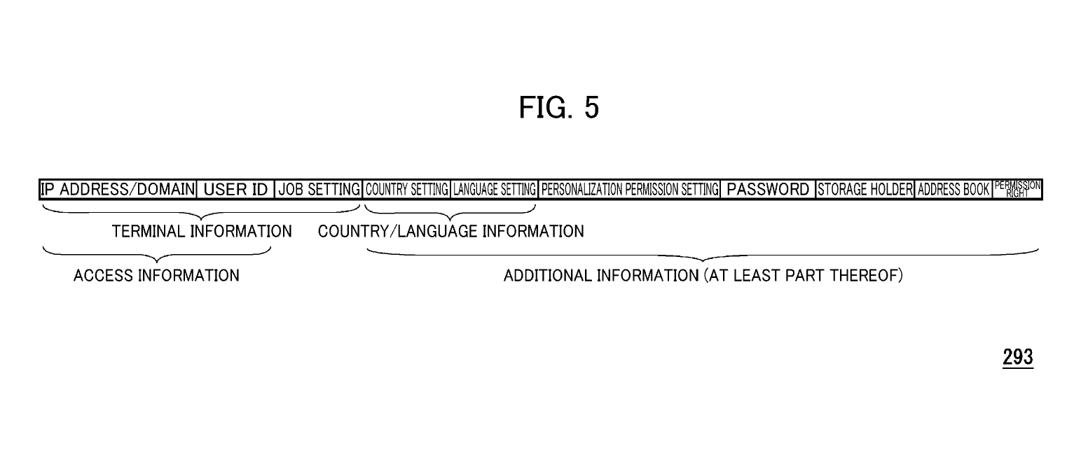

The detail of the property information 293 stored in the storage unit 290 of the terminal 200 will be described with reference to FIG. 5. For the personalization setting, the property information 293 is stored in the account information 90 of the image forming apparatus 1 for each account. The property information 293 stores attribute information including IP address/domain, user ID (account ID), job information, country setting, language setting, personalization permission setting, password, storage folder, address book, permission right and the like.

The IP address/domain stores addresses including a terminal name on the OS, IPv4 or IPv6 address, subnet mask, gateway and the like of the terminal 200, and domain name, URL/URI, E-mail address, mobile/extension number and the like. This address serves as apparatus specific information for accessing from the image forming apparatus 1 to the terminal 200. In addition, the IP address/domain may also store a host name, URL/URI, domain name, IP address and the like of the image forming apparatus 1.

The user ID stores a user ID, an account name, a user name and the like necessary for login with the OS or external access to the storage folder 294. In addition, the user ID may store an account ID and the like of the image forming apparatus 1. The user ID may store a user's actual name, its kana letters and the like.

The job information stores settings concerning various jobs including print job of the driver 291 of the terminal 200. The setting information, which includes print setting, scanning setting, setting of transmission/receiving destinations, and the like and which corresponds to various functions of the image forming apparatus 1, is stored as the settings concerning various jobs.

The country setting stores a country setting including locales of the OS and the image forming apparatus 1. The country setting may be acquired using an application programming interface (API) or the like of the OS from the driver 291. In addition, the country setting can store information including an OS type, a release port, available www browser and the like.

The language setting stores a language setting for the OS and the image forming apparatus 1. The language setting may be acquired using the driver 291.

The personalization permission setting stores user's setting about whether personalization setting is permitted. The personalization permission setting can store following statuses, that is, “no setting” which means that a user has not yet made any setting, “permitted” which means that personalization permission has been set by a user, and “not-permitted” which means that personalization rejection has been set. In case of the “no setting”, these statuses can be changed upon printing when a confirmation dialog which will be described below is displayed or a password is input. In addition, these statuses can be changed using GUI of the driver 291.

The password stores by enciphering the password, security code number or the like of an account concerning user's ID. Furthermore, the password can store a password of the account of an external server, a password of a storage folder and the like.

The storage folder stores the name of a folder containing image data which is read by the document reading unit 2 of the image forming apparatus 1 and which is received from the image forming apparatus 1, the name of the folder being stored in the terminal 200.

The address book stores address book information which is a transmission/receiving destination of each user, an address of the image forming apparatus 1 and addresses of other servers. Furthermore, the address book can store an address such as URL of user's homepage and the like.

The permission right stores information concerning permission right control about a number of possible copies in color/monochrome, possibility/impossibility of fax transmission/receiving, billing information, billing department, image data storage period in temporary folder/personal folder and the like.

As well as these matters, the property information 293 can store a user's address, telephone number, credit card number and the like.

Of the property information 293, the IP address/domain, user ID, job information and the like may be used as terminal information which may be included in the print data 292. Of the terminal information, the IP address/domain and the user ID serve as access information necessary for general authentication for connecting to the terminal 200. Basically, using information which can be displayed on a status screen of the GUI of the driver 291 as the terminal information is preferable from the viewpoint of privacy policy and security. Of information of the property information 293 except the IP address/domain, user ID and job information, at least part thereof is used as information necessary for personalization setting (additional information). For example, password is additional information necessary for changing a file in the terminal 200, for example, storing image data obtained by scanning into the storage folder of the terminal 200 by SMB or FTP. Furthermore, country/language information of the terminal 200, which is acquired by general authentication requiring not so much severe authentication, can be used as country/language setting for the property information 293.

### (Detailed Configuration of Image Forming Apparatus 1)

The detailed configuration of the image forming apparatus 1 will be described with reference to FIG. 3. The personalization setting unit 81 of the control unit 8 is a member configured to carry out personalization setting by setting the property information 293 in the account information 90. The personalization setting unit 81 acquires terminal information from the print data 292 acquired by the network transmission/receiving unit 12. When the image forming apparatus 1 is connected to the terminal 200 or the like with the access information of the terminal information, the personalization setting unit 81 acquires the property information 293 including additional data and sets the property information 293 in the account information 90 to carry out the personalization setting.

Thus, the personalization setting unit 81 includes server program (service, daemon)/client program which uses Internet protocol such as world wide web (WWW) server, simple mail transfer protocol (SMTP)/post office protocol (POPS) server, server message block (SMB), file transfer protocol (FTP) server and the like, and acquisition program for the print data 292 (see FIG. 4)/property information 293 which is created/set at the terminal 200 using machine language, Java (registered trademark), JSP (Java (registered trademark) servlet), common gateway interface (CGI) or the like. The personalization setting unit 81 can upload a file to other server (not shown). In addition, the personalization setting unit 81 may be provided with a server for calling a program or each function stored in the storage unit 9 of the image forming apparatus 1, such as Cron server, Telnet, SSH server and the like.

The account information 90 is a database which stores a variety of information of the image forming apparatus 1 such as the property information 293 for each user account. When acquiring the print data 292 from the terminal 200, the account information 90 can acquire and store the terminal property information 293 of the terminal 200 by print personalization processing described below. In the meantime, each user can input in advance a variety of information concerning the terminal 200 of each user through the operation panel 6, web browser of the terminal 200 or the like. In addition, a guest user can be registered in the account information 90. Information stored in the property information 293 of each user in the account information 90 can be input/changed through the operation panel unit 6.

### Print Personalization Processing by Image Forming System X

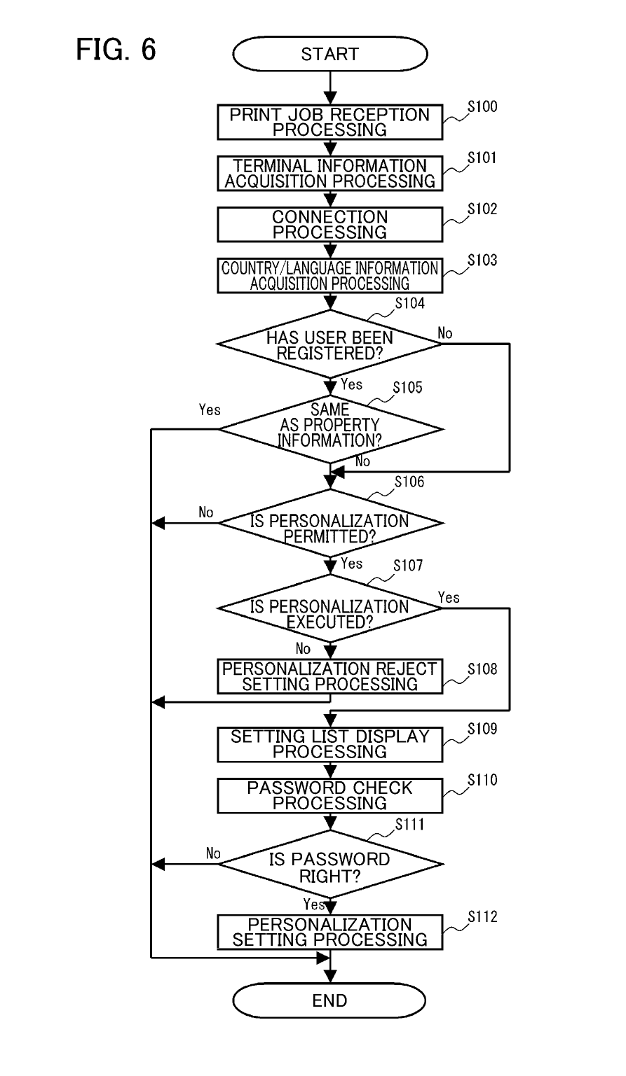

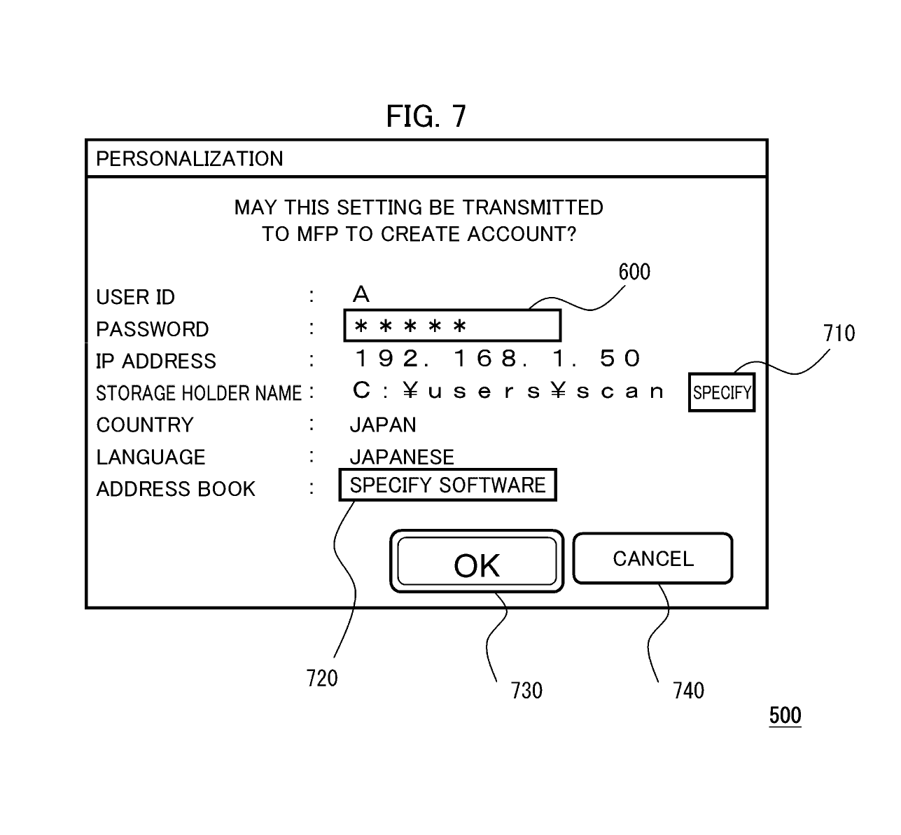

Next, print personalization processing with the image forming system X according to an embodiment of the present disclosure will be described with reference to FIGS. 6 and 7. When receiving the print data 292 from the terminal 200, the image forming apparatus 1 acquires the property information 293 and automatically carries out personalization setting. That is, when printing is executed through the driver 291 from the terminal 200 of the present embodiment, the personalization setting of the image forming apparatus 1 can be carried out. As a consequence, a number of settings including the personalization setting can be achieved by only printing, so that an ordinary user can personalize easily. Hereinafter, the print personalization processing will be described in detail with respect to each step with reference to a flowchart shown in FIG. 6.

### (Step S100)

First, the personalization setting unit 81 executes print job reception processing. The personalization setting unit 81 starts a print job by receiving the print data 292 through the network transmission/receiving unit 12. More specifically, the personalization setting unit 81 decodes the PDL or the like of the print data 292 and printing by the recording unit 7 is started.

### (Step S101)

Next, the personalization setting unit 81 executes terminal information acquisition processing. When decoding the print data 292, the personalization setting unit 81 acquires terminal information contained in the print data 292. As described above, as the terminal information, the personalization setting unit 81 can acquire access information including an IP address/domain of the terminal 200, user ID and the like, which access information is necessary for access to the terminal 200. In addition, the personalization setting unit 81 can acquire a job setting for printing or the like. The terminal 200 can confirm and set the terminal information contained in the print data 292 through the GUI of the driver 291.

### (Step S102)

Next, the personalization setting unit 81 executes connection processing. The personalization setting unit 81 connects to the terminal 200 through the network 100 using the IP address/domain of the terminal 200. Upon the connection, the personalization setting unit 81 tries for a login to the terminal 200 using an account necessary for general authentication connection, including connections under a user name without password, guest connection, and anonymous connection. At this time, a user can try for connection by using multiple ordinary port settings or protocols preferable for connection of the OS of the terminal 200.

### (Step S103)

Next, the personalization setting unit 81 executes country/language information acquisition processing. The personalization setting unit 81 acquires part of the property information 293 of the terminal 200 which can be usually acquired on a network, by the aforementioned general authentication connection. Here, the personalization setting unit 81 can acquire country setting/language setting of the property information 293 mainly with the country/language information which is information of the OS of the terminal 200. The personalization setting unit 81 can be connected to the driver 291 at “no-authentication mode” to acquire information. In addition, the personalization setting unit 81 can acquire other information of the property information 293, for example, user's permission right. The personalization setting unit 81 may acquire the country setting/language setting from a response from the OS of the terminal 200 through the network 100.

### (Step S104)

Next, the personalization setting unit 81 determines whether a user of the terminal 200 has been registered by use of the above-described terminal information and country/language information. If the user of the terminal 200 who has tried for the connection has been already registered, the personalization setting unit 81 determines YES with reference to the account information 90. In other cases, the personalization setting unit 81 determines NO. In case of YES, the personalization setting unit 81 can bring forward the processing to step S105. In case of NO, the personalization setting unit 81 brings forward the processing to step S106.

### (Step S105)

Next, the personalization setting unit 81 determines whether the terminal information and country/language information acquired from the terminal 200 is the same as the property information 293 of a user stored in the account information 90. If the property information 293 of the same user has been already stored, the personalization setting unit 81 determines YES. In other cases, the personalization setting unit 81 determines NO. In case of YES, the personalization setting unit 81 terminates the print personalization processing because the personalization has been completed. In case of NO, the personalization setting unit 81 brings forward the processing to step S106.

### (Step S106)

Next, the personalization setting unit 81 determines whether the user has made setting for permitting the personalization. More specifically, if the job setting of the property information 293 of a user stored in the account information 90 is about permission of the personalization or no job setting has been made, the personalization setting unit 81 determines YES. Conversely, if the personalization setting is rejected before or the user has made setting of not permitting the personalization through the GUI of the driver 291, the personalization setting unit 81 determines NO. In case of YES, the personalization setting unit 81 brings forward the processing to step S107. In case of NO, the personalization setting unit 81 skips the personalization processing and terminates the print personalization processing. If the personalization setting is not permitted, the personalization setting unit 81 may change the setting so as to permit the personalization setting using the GUI of the driver 291 at the terminal 200.

### (Step S107)

Next, the personalization setting unit 81 determines whether the user executes the personalization. More specifically, if the aforementioned job setting has been made to permit the personalization, the personalization setting unit 81 determines YES. If the personalization permission setting has been not made yet by a user, the personalization setting unit 81 instructs to display a confirmation dialog which says “Personalization setting is made? YES or NO” through, for example, the driver 291 of the terminal 200. The personalization setting unit 81 acquires information of a result about YES or NO with which the user responds to the confirmation dialog. In case of YES, that is, if the personalization permission setting is set to “permission” or the information of a result of the confirmation dialog is YES, the personalization setting unit 81 brings forward the processing to step S109. In case of NO, that is, if the information of the result is NO, the personalization setting unit 81 brings forward the processing to step S108.

### (Step S108)

If the user responds to the confirmation dialog with NO so that the response information is NO, the personalization setting unit 81 executes personalization reject setting processing. The personalization setting unit 81 sets “not-permitted” in the personalization permission setting of the property information 293 of a user stored in the account information 90 and stores the status.

### (Step S109)

If a user responds to the confirmation dialog with YES so that the response information is YES, the personalization setting unit 81 executes setting list display processing. More specifically, the personalization setting unit 81 transmits a request about the property information 293 including the additional information to the terminal 2 through the network transmission/receiving unit 12. The control unit 280 of the terminal 200 displays a list of respective attributes of the property information 293 acquired by the driver 291. When this display is executed, the property information 293, which is automatically acquired and set by the driver 291 in the above-described steps, can be edited.

Referring to FIG. 7, a screen example 500 shows a list of the property information 293 stored in the storage unit 290 in the terminal 200. This list is displayed by the control unit 280 of the terminal 200 by use of the driver 291. These serve as information for user specific setting relating to the personalization setting. As shown in the screen example 500, the list indicates additional information for the personalization setting, for example, a form, buttons and the like which a user inputs with a keyboard or mouse of the input section 260. An indication space 600 is a form to which a password is to be input. A button 710 is a button for specifying a storage folder. When pressing of the button 710 is detected, the control unit 280 can specify the storage folder 294 of the storage unit 290 and create a storage folder 294. A button 720 is a button for specifying an address book. The address book can be imported from a variety of applications. A button 730 is a button for instructing transmission when input is completed. The terminal 200 detects that the button has been pressed, and transmits the property information 293 stored in the storage unit 290 of the terminal 200 to the personalization setting unit 81 of the image forming apparatus 1. A button 740 is a button for canceling authentication. Pressing this button inhibits information concerning authentication from being transmitted to the personalization setting unit 81. In addition, a “clear” button for deleting a message written in the form may be provided. Furthermore, it is permissible to set up print setting for a printer, keyboard setting, and a user's permission right for use upon permission right control of the image forming apparatus 1.

### (Step S110)

Next, the personalization setting unit 81 executes password check processing. First, the personalization setting unit 81 receives the property information 293 transmitted from the terminal 200 by the aforementioned setting list display processing from the network transmission/receiving unit 12. Then, if a password is contained in the received property information 293, the personalization setting unit 81 makes login accompanied with password authentication to the terminal 200 again using the password, and transmits a dummy file by, for example, SMB.

### (Step S111)

Next, the personalization setting unit 81 determines whether the password is right. More specifically, if the login is successful and the above-described transmission of a dummy file succeeds, the personalization setting unit 81 determines that the password is right and then YES. In other cases, it is regarded that the user does not desire the personalization setting, and the personalization setting unit 81 determines NO. In case of YES, the personalization setting unit 81 brings forward the processing to step S112. In case of NO, the personalization setting unit 81 terminates the print personalization processing. In this case, the same processing may be performed as the aforementioned personalization reject setting processing. In addition, the confirmation dialog may be displayed to request the user to confirm. Furthermore, the personalization permission setting may be set to “no setting” by regarding that no confirmation has been made only this time.

### (Step S112)

If a password input by a user is correct, the personalization setting unit 81 executes the personalization setting processing. The personalization setting unit 81 executes the personalization setting using the property information 293 acquired from the terminal 200. More specifically, the personalization setting unit 81 creates an account of the user and stores the property information 293 in the account information 90. The personalization setting unit 81 stores the personalization permission setting as “permission”. These processings enable the personalization setting to be carried out at the time of printing by the user. As described above, if the personalization permission setting has not been made by the user during output of print data and the user has not selected NO even once through the confirmation dialog, the personalization setting unit 81 can execute the personalization setting. Then, the print personalization processing is terminated.

The above-described configuration enables the following advantageous effects to be achieved. The image forming apparatus 1 of the present embodiment acquires at least part of the property information 293 from the print data 292 as terminal information, makes access to the terminal 200 using this terminal information, and then receive additional information which is a remainder of the property information 293 so as to execute the personalization setting. As a result, the image forming apparatus 1 of the present embodiment can execute the personalization setting, which is difficult to do by an ordinary user except an administrator, by only printing through the driver 291 of the terminal 200. That is, even if the user “does not know where the personalization setting by the GUI of the driver 291 has been provided”, “does not know that the function of the personalization exists”, “does not know technical terms such as IP address, host name”, or “does not know how the IP address/domain should be searched”, the personalization can be achieved easily. That is, the personalization setting can be made with only knowledge about outputting a print job from the terminal 200, so that a number of settings can be made during output of print. Because a language for use in OS can be set up in the personalization setting, an effect, that an operation error originating from a difference of language is eliminated, can be obtained. Furthermore, because the IP address/domain of the terminal 200 can be automatically input by use of the terminal information, the image forming apparatus 1 can be used without any search on the IP address/domain.

The image forming apparatus 1 of the present embodiment acquires only information displayed ordinarily by the driver 291 as the terminal information acquired from the print data 292, which is preferable from the viewpoint of privacy policy and security.

The image forming system X can be applied to information processing apparatuses other than the image forming apparatus. In addition, the image forming system X may be a server or the like in which a separate printer is connected via a USB or the like. Although the above embodiment has described that the additional information is acquired after the access information is acquired, the present disclosure is not restricted to this description. At least part of the property information 293 may be transmitted directly to the terminal 200 from the driver 291.

The configuration and operation of the above embodiment are just an example. The configuration and operation thereof may be changed appropriately within a scope not departing from the gist of the present disclosure.

1. An image forming apparatus comprising: a receiving unit that receives print data concerning a print job through a network from a terminal; and
a terminal specific information setting unit that acquires terminal specific information of the terminal contained in the print data and executes user specific setting using the terminal specific information.

2. The image forming apparatus according to claim 1, wherein the terminal specific information contains job setting corresponding to the job, and
wherein the terminal specific information setting unit acquires the job setting from the print data and uses the job setting for the user specific setting.

3. The image forming apparatus according to claim 1, further comprising a transmission unit,
wherein the terminal specific information contains access information for connecting to the terminal,
wherein the transmission unit is connected to the terminal using the access information and requests for additional information other than the access information, and
wherein the terminal specific information setting unit uses the additional information for the user specific setting.

4. The image forming apparatus according to claim 1, wherein the terminal specific information setting unit uses, as the terminal specific information, at least one of the address of the terminal, user ID, password necessary for changing a file of the terminal, country setting, language setting and a storage folder name of the terminal.

5. An image forming system including: a terminal having a first network transmission/receiving unit that is connected to a network to transmit print data; and
a second network transmission/receiving unit that receives print data from the terminal,
wherein the terminal comprises:
a storage unit for storing terminal specific information of the terminal; and
a control unit which causes the terminal specific information to be included in the print data to be printed by the image forming apparatus, and
wherein
the image forming apparatus comprises a terminal specific information setting unit that acquires terminal specific information of the terminal from the print data and executes user specific setting for connecting to the terminal using the terminal specific information.

6. An image forming method comprising:
receiving print data concerning a print job through a network from a terminal; and
acquiring terminal specific information of the terminal contained in the print data and executing user specific setting using the terminal specific information.
